(19) United States
(12) Patent Application Publication
(10) Pub. No.: US 2011/0109019 A1
(43) Pub. Date: May 12, 2011

(54) EXFOLIATING CONTAINER

(75) Inventor: Laure THIEBAUT, Clichy (FR)

(73) Assignee: L'OREAL, Paris (FR)

(21) Appl. No.: 13/006,170

(22) Filed: Jan. 13, 2011

Related U.S. Application Data
(62) Division of application No. 11/190,010, filed on Jul. 27, 2005.
(60) Provisional application No. 60/601,607, filed on Aug. 16, 2004.

(30) Foreign Application Priority Data
Jul. 27, 2004 (FR) 04 51667

(51) Int. Cl. B29C 49/04

(52) U.S. Cl. 264/540

(57) ABSTRACT

A process for producing a container for a cosmetic product, the container including a body having at least one opening, and a closure element for closing or restricting the opening in the body. The container includes at least one abrasive element located on the outer surface of the body or of the closure element, with the abrasive element being configured to exfoliate the skin.

### CROSS REFERENCE

This application is a division of and is based upon and claims the benefit of priority under 35 U.S.C. §120 for U.S. Ser. No. 11/190,010, filed Jul. 27, 2005, and the benefit of priority under 35 U.S.C. §119(e) for U.S. Provisional Application No. 60/601,607, filed on Aug. 16, 2004, and claims the benefit of priority under 35 U.S.C. §119 from French Application No. 04 51667, filed Jul. 27, 2004, the entire contents of each of which are incorporated herein by reference.

### FIELD OF THE INVENTION

The present invention relates to a device for cleansing the body. A particularly preferred form includes a container which is designed to contain a cosmetic product and which includes an exfoliating element.

### BACKGROUND OF THE INVENTION

### Discussion of Background

To remove dead skin cells, use is often made of cosmetic products containing exfoliating particles such as, for example, polyethylene powder, fine quartz or nutshell particles, or desquamating products having a biological action on the skin. However, such cosmetic products are sold without an applicator so that users have to apply the product using a traditional facecloth, a sponge or their own hands. Alternatively, gloves, for example massage gloves, have been used to exfoliate the skin.

U.S. Pat. No. 5,504,963 describes a back scrubber device, which includes a netting formed of intertwined cords. US patent application US 2003/0,208,871 also describes a netting. There is a need for a skin exfoliating device which is simple and inexpensive to produce. There is also a need for a device having an exfoliating power similar to that of a massage glove, without it being necessary to add an exfoliating product. There is also a need for a device which is practical to use.

### SUMMARY OF THE INVENTION

According to one example, the invention relates to a container for a cosmetic product which includes a body having at least one opening, and a closure for closing or restricting the opening in the body. The container includes at least one abrasive element located on the outer surface of the body or of the closure element, with the abrasive element being configured to exfoliate the skin. According to a preferred form, the abrasive element has an abrasive power of between 0.01 and 0.02 g/cm²/min, inclusive.

Because the abrasive element is on the outer surface of the container or applicator, it may be used when the container is closed. The body of the container or the closure element can thus serve as a handle for applying the abrasive element to the skin, making it possible to exfoliate the skin very practically and effectively.

The abrasive element has an abrasive power enabling it to exfoliate the skin, i.e. enabling it to remove at least some of the dead cells from the surface of the skin by moving it over the skin.

The abrasive power of the abrasive element corresponds to the amount of plaster removed per minute by one square centimeter of an abrasive surface applied to a plaster tile 50 mm thick using a Black & Decker CD400 135W sander, with the pressure exerted on the plaster tile resulting from the weight of the sander regarding, with additional force applied only to move the sander in the direction of the plane of the abrasive surface.

The abrasive element can include, for example, a cellular material having a plurality of cells opening onto the outer face via at least one outward edge. The cellular material can be a foam, in particular a closed-cell foam. The foam can also be a thermoplastic foam, in particular made of a polyolefin such as a polyethylene or a polypropylene. Also by way of example, the foam can have a density lower than 70 kg/m³, or lower than 40 kg/m³. By using a foam to make the abrasive element, an inexpensive exfoliating element is obtained.

The thickness of the abrasive element can be, for example, greater than or equal to 1 mm, in particular between 4 mm and 5 cm, inclusive.

According to one example, the abrasive element can include passages opening out, on the one hand, on the outer face of the abrasive element and, on the other hand, inside the body. With this arrangement, the passages can provide direct communication of the product inside the container to the exterior of the container for the product to exit the container.

The abrasive element can be located on a side wall of the body. Alternatively, the abrasive element can be located on a top wall of the closure means. The abrasive element can, for example, be adhesively bonded or welded to the body or to the closure means.

By way of example, the body can include deformable walls, in particular elastically deformable walls. The container may be in the form of a tube, a jar or a bottle. The container can contain a cosmetic product, in particular a cleansing product. The container may also contain an exfoliating product or a desquamating product. The container could also contain a product in the form of a gel, a cream or a mousse.

According to another of its aspects, the invention also relates to a process for producing a container as described above. According to a preferred example, the process includes placing an abrasive element in a mould, placing a preform having an opening in the mould, and deforming, by exerting internal pressure on the preform to make it substantially match the shape of an inside surface of the mould and of the abrasive element.

By placing the abrasive element in the mould, a container which can be used both to contain a product and to exfoliate the skin is obtained simply and inexpensively. The process does not in fact require any additional step with respect to a process for producing the container alone. Also, with this process, the abrasive element can be integrally molded with the body of the container.

The preform, which may be produced by injection moulding or by extrusion, may be deformed by blow moulding, for example.

As should be apparent, the invention can provide a number of advantageous features and benefits. It is to be understood that, in practicing the invention, an embodiment can be constructed to include one or more features or benefits of embodiments disclosed herein, but not others. Accordingly, it is to be understood that the preferred embodiments discussed herein are provided as examples and are not to be construed as limiting, particularly since embodiments can be formed to practice the invention that do not include each of the features of the disclosed examples.

### BRIEF DESCRIPTION OF THE DRAWINGS

In addition to the features described above, additional features and arrangements will become apparent from the description below, in relation to non-limiting embodiments, described with reference to the attached figures; in which:

FIG. 1 shows a perspective view of a first embodiment of a container according to the invention;

FIG. 2 shows a partial section of FIG. 1;

FIG. 3 shows a perspective view of the container of FIG. 1 during use;

FIGS. 4 and 5 are perspective views of other embodiments of a container according to the invention;

FIG. 6 shows the container of FIG. 5 during use; and

FIG. 7 is a side cross-sectional view of another embodiment of a container according to the invention.

### DETAILED DESCRIPTION OF THE PREFERRED EMBODIMENTS

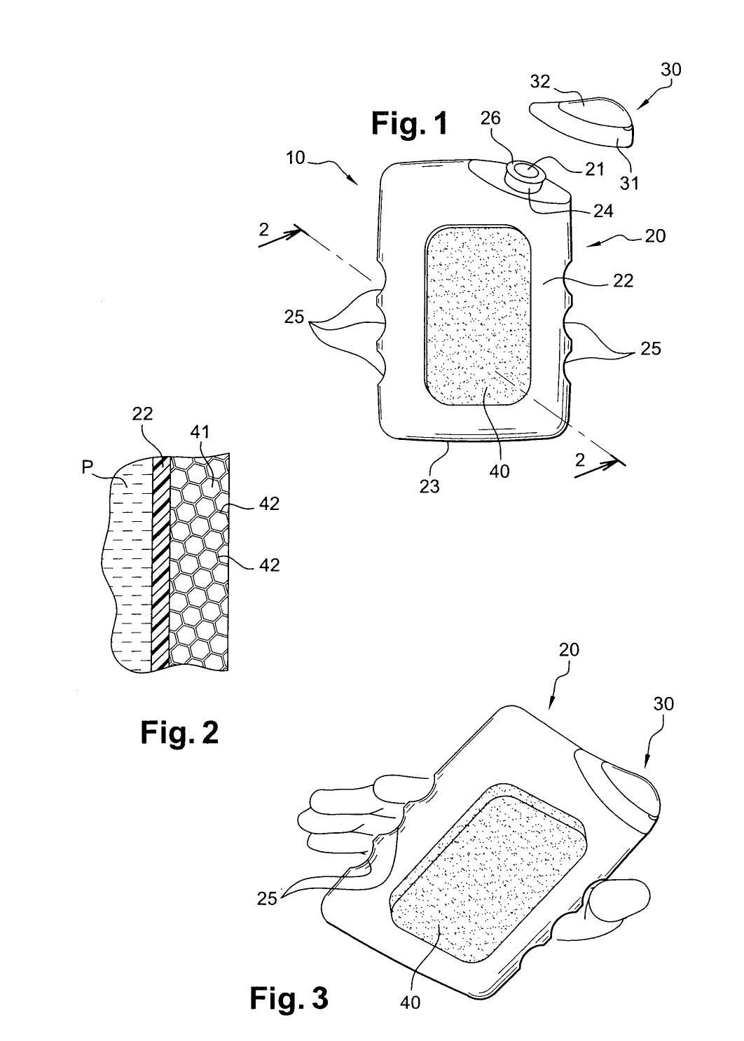

As shown by way of example in FIG. 1, the container 10 includes a bottle designed to contain a liquid product, preferably a cosmetic product, for example a shower gel or facial cleanser.

The bottle 10 includes a body 20, having rectangular overall shape, a side wall 22 having a substantially elliptical cross section, and a substantially flat base 23. In the illustrated example, the side wall 22 of the body includes two relatively flat large faces, with these faces being connected by two rounded edges having hollows 25 for receiving the user's fingers to make it easier to grasp the container. The side wall 22 is also preferably elastically deformable to make it easier to extract the product.

At the other end from the base 23, the body 20 has a neck 24, preferably made as a single piece with the rest of the body. The neck 24 defines an opening 21 via which the product can be extracted. The body of the bottle is made of polyethylene, for example.

The opening 21 in the body of the bottle can be closed off by a closure element such as closure cap 30 designed to snap-fasten on the neck 24 in this example. The cap 30 includes a fastening skirt, not visible in the figures, which is fastened to the neck 24 by a fastening arrangement including, for example, a groove designed to receive a protuberance, such as an annular bead 26 provided on the neck 24. Alternatively, for example, the cap may be screwed onto the neck of the bottle.

The cap also includes a cover skirt 31 which follows the outline of the body in the illustrated example so as to obtain a bottle of substantially rectangular overall shape.

At the top, the cover skirt 31 is connected to a transverse wall (not shown) which includes an orifice designed to be opposite the opening 21 in the neck of the bottle when the cap is fastened on the bottle.

The cap 30 also includes a lid 32 hinged to the cover skirt 31 and designed to close off the orifice.

According to the invention, the body 20 includes, on its outer surface, an abrasive element 40 for exfoliating the skin. According to a particular example, the abrasive element 40 can include a cellular material, preferably a closed-cell foam made of non-crosslinked polyethylene. For example, the foam can have a density of between 25 and 65 kg/m³, for example, approximately 35 kg/m³.

As can be seen in detail in FIG. 2, the abrasive element 40 in this example includes a plurality of cells 41 opening onto its outer face via at least one outward edge 42. Such a configuration makes it possible to define a relatively abrasive surface.

The density of the foam can be selected according to the exfoliating power it is desired to obtain. Specifically, for the same material, the denser the foam the smaller the cells and, hence, the more outward edges 42 there are and the greater the exfoliating power of the foam.

According to a preferred example, the abrasive element has an abrasive power of between 0.01 and 0.02 g/cm²/min, inclusive. To perform this measurement, an abrasive surface approximately 166.5 cm² (9 cm×18.5 cm) is applied to a plaster tile 50 mm thick using a Black & Decker CD400 135W sander, with the pressure exerted on the plaster tile resulting from the weight of the sander, in which only the movement in the plane of the abrasive surface is forced, for a period of time. The amount of plaster removed from the plaster tile during this time is then measured.

According to this method, the abrasive power of the non-crosslinked polyethylene closed-cell foam, having a density of 35 kg/m³, was measured, with this abrasive power being measured to be 0.015 g/cm²/min. By way of comparison, the same measurement of abrasive power was performed for other items under the same conditions. The results obtained were as follows: for a sheet of No 0 sandpaper, an abrasive power of 0.014 g/cm²/min is obtained, and for a sheet of No 2 sandpaper an abrasive power of 0.018 g/cm²/min is obtained. For a soft foam, PTZ® or Plastazote® (crosslinked low-density polyethylene foam) having a density of 45 kg/m³, an abrasive power of 0.001 g/cm²/min is obtained.

The abrasive element 40 is located, for example, on one of the substantially flat large faces of the side wall 22 of the bottle body. The abrasive element has for example the shape of a substantially rectangular sheet approximately 7 mm thick.

The abrasive element can have any shape suitable for the surface of the bottle on which it is fixed and also for the surface to be exfoliated. The abrasive element may, for example, be an oval, teardrop-shaped or even flower-shaped sheet.

As a variant, there may be an abrasive element on each of the large faces of the side wall 22, and the two abrasive elements can be identical or different. When the two abrasive elements are different, foams having a different exfoliating power are preferably selected so as to allow the user to choose between more or less gentle exfoliation.

The bottle 10 may be made in the following manner, for example.

First, a polyethylene foam is produced by extrusion, by blending polyethylene and isobutane to obtain a block of foam with cells containing isobutane. This block of foam is then stored for degassing so that ambient air replaces the isobutane in the cells. During degassing, the polyethylene polymerizes to form the closed cells of the foam, which are then relatively rigid. The block of foam thus obtained is smooth on the surface owing to the presence of a skin which forms on the walls of the extrusion mould. This block of foam is then cut to obtain at least one face with cut cells, with this face being intended to form the exfoliating surface of the abrasive element.

The block of foam is then cut to the desired size to obtain the abrasive element 40. Preferably, the foam is cut in the form of a sheet around 7 mm thick, having two large faces at least one of which includes the cut cells, with the face having the cut cells facing the wall of the mould.

This sheet of foam is placed in a mould whose cavity has the shape of the body of the bottle it is desired to produce, on the wall intended to form one of the substantially flat faces of the side wall of the body.

By way of example, the sheet is held in the mould by any heat-resistant attachment means. For example, it may be fixed to the mould using hooks, double-sided adhesive, Velcro®, or using a suction system. It may also be held in a recess made in the inside wall of the mould, with the dimensions of the recess being slightly smaller than those of the sheet of foam so as to keep it in place.

Preferably, the foam is compressed in the mould in such a way that when the bottle is taken out of the mould the foam expands and forms a relief on the bottle. When the foam is held in the mould using the recess, it is not necessarily compressed.

Next, polyethylene is injected into this mould to produce a preform comprising a tubular part closed at its lower end and connected, at the top, to the neck defining the opening 21. A hot gas is then injected through the opening 21 into the preform, so as to dilate the tubular part, which is sufficiently hot, until it substantially matches the shape of the inside surface of the mould and of the face of the sheet of foam facing the inside of the mould.

Since the preform is still hot, the face of the sheet facing the inside of the mould melts slightly in contact with the bottle and, on cooling, becomes welded to the external wall of the bottle. Moreover, the outer surface of the bottle may mould itself around the cells 42 of the foam due to the blow moulding. The abrasive element 40 is thus securely fixed to the body 20 of the bottle.

The temperature of the preform and the pressure it is under when the gas is injected are selected so that the foam can weld itself to the bottle wall and so that the foam does not melt in the mould and air trapped in the cells of the foam does not explode.

For example, when the foam and the bottle are made of polyethylene, the temperature and pressure parameters can be very close to those used to make a conventional polyethylene bottle. The polyethylene preform is at a temperature of between 50 and 100° C., for example, and is subjected to a pressure of between 8 and 10 bar.

Instead of being produced by injection blow moulding, the body of the bottle may be formed by other expedients, for example, by extrusion blow moulding.

Instead of being welded to the side wall of the body of the bottle, the sheet of foam may be attached by other expedients, for example, it can be adhesively bonded, in particular using a hot adhesive or a double-sided adhesive. The body of the bottle can then be produced conventionally, without placing the sheet of foam in the mould beforehand.

As yet another alternative, the foam may be welded on the wall of the bottle outside the mould, for example by mirror welding.

To use the bottle, the user takes the bottle by its side wall 22, placing his figures in the hollows 25 provided on the edges of the body, with the bottle closed by the cap 30. He or she can then apply the foam 40 to the skin, as shown in FIG. 3, by rubbing gently, after having applied shower gel to the area to be treated, for example. By using the bottle as a handle, the user thus has a good grip for exfoliation purposes. Moreover, the combined effect of the abrasive surface and of the product increases the effectiveness of exfoliation.

After each exfoliation, the user can rinse the bottle in water to clean the foam. The foam cleans easily because it preferably includes closed cells, so that any dead skin that might get caught in the foam stays at the surface.

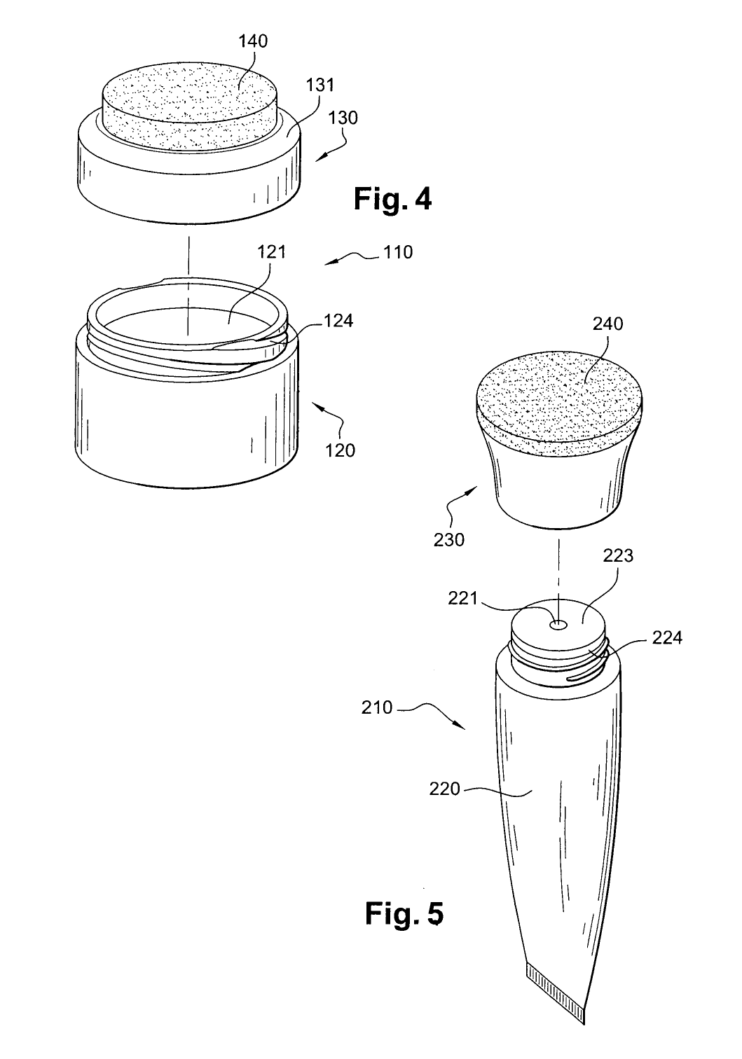

According to another example shown in FIG. 4, the container 110 can be in the form of a jar including, for example, an axisymmetric cylindrical body 120 having, at the top, a threaded annular part 124 defining an opening 121. The opening 121 is preferably relatively large so as to allow, for example, the product contained in the body of the container to be extracted using an applicator inserted through the opening.

A closure element or cover 130 is then provided to close off the opening 121 in the body by screwing it onto the threaded annular part. The cover includes a flat top face 131 covered with an abrasive element 140. This time the abrasive element 140 is in the shape of a disc. The abrasive element 140 can be adhesively bonded to the cover or be welded by overmoulding onto the cover.

According to a variant of this embodiment shown in FIG. 7, the body 320 of the container can be designed to contain a metered quantity of product for single use, and the body can be refilled by the user for each use. The body 320 is in the shape of a handle, for example. It also has, at the top, a threaded annular part 324 defining an opening 321.

A cover 330 is then provided to restrict the opening 321 in the body by screwing it onto the threaded annular part. The cover includes a flat top face 331 covered with an abrasive element 340. In this example, the abrasive element has passing through it passages 322 opening out, on the one hand, on the outer surface of the abrasive element and, on the other hand, inside the body.

According to this variant, the user can apply the product while rubbing the surface with the abrasive element at the same time, since the product coming from the body of the container is conveyed to the outer face of the foam via the passages 322.

According to another embodiment shown in FIG. 5, the container 210 can include a tubular body 220 with flexible walls. In the example illustrated, the container includes a threaded neck 224 at a first end, with the neck being partly closed off by a transverse wall 223 passed through by an orifice 221. The tubular body 220 is closed at the other end opposite from the neck by a pinched portion so as to form a tube.

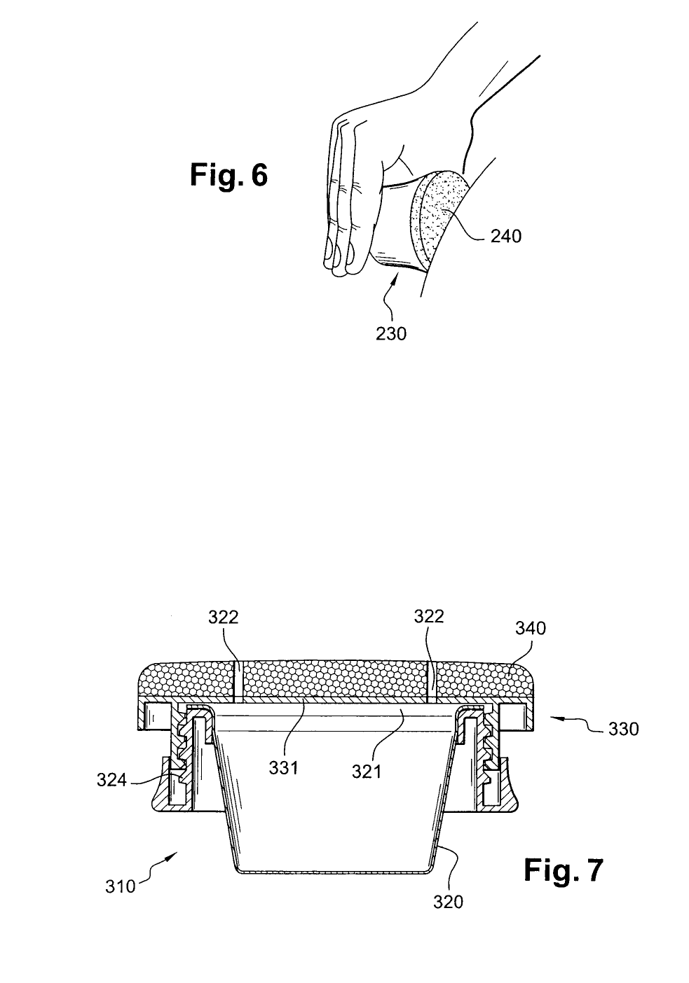

A closure element such as closure stopper 230 is provided, for example, to be screwed onto the neck by virtue of a threaded skirt. The stopper is substantially frustoconical in the illustrated example, and includes a flat upper transverse wall, covered with an abrasive element 240. Preferably, the side wall of the frustoconical stopper flares out towards its upper wall so as to make it easier for the user to grip the cap when he or she applies it to the skin, as shown in FIG. 6, if using the stopper alone. The user may also hold the whole container with the tube closed off by the stopper so as to apply the foam.

This embodiment is particularly suitable for application to the face since the surface area of the foam is relatively small.

As a variant, the body of the container can be surmounted by a pump or a valve.

In the above detailed description, reference has been made to preferred embodiments of the invention. Obviously, numerous modifications and variations of the present invention are possible in light of the above teachings. It is therefore to be understood that within the scope of the appended claims, the invention may be practiced otherwise than as specifically described herein.

What is claimed:

1. A method of producing a container including a body having at least one opening, a closure element which at least partially closes the opening in the body, and at least one abrasive element located on one of an outer surface of the body or the closure element, the abrasive element is configured to exfoliate the skin and has an abrasive power of between 0.01 and 0.02 g/cm²/min, inclusive, the method comprising:
placing an abrasive element in a mold;
placing a preform having an opening in the mold;
deforming the perform by exerting internal pressure on the preform to make it substantially match the shape of an inside surface of the mould and of the abrasive element.

2. The method according to claim 1, wherein the preform is deformed by blow molding.

3. The method according to claim 1, further comprising a step of producing the preform by injection molding.

4. The method according to claim 1, further comprising a step of producing the preform by extrusion.
